(19) United States
(12) Patent Application Publication
(10) Pub. No.: US 2009/0327339 A1
(43) Pub. Date: Dec. 31, 2009

(54) PARTITION TEMPLATES FOR MULTIDIMENSIONAL DATABASES

(75) Inventors: Alexander Berger, Sammamish, WA (US); Mosha Pasumansky, Redmond, WA (US); Dimitry Berger, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/163,387

(22) Filed: Jun. 27, 2008

(51) Int. Cl. G06F 17/30

(52) U.S. Cl. 707/103 Y; 707/E17.055

(57) ABSTRACT

Systems and methods for storing and retrieving data items in multidimensional databases are provided. Data partition templates are generated for grouping data partitions that are similar to one another, that is, that contain information specified according to particular common characteristics (for instance, time, product, geography, etc.). The data partition template includes one or more rules concerning how the data stored in partitions associated with the data partition template should be processed. A template object having the rule(s) associated therewith is generated for the data partition template. Once a data partition template is generated, a plurality of partitions are generated in accordance therewith. Each of the plurality of partitions utilizes the template object associated with the data partition template. In this way, the overhead associated with managing the partitions is significantly decreased.

### BACKGROUND

Multidimensional databases often use partitioning to improve query processing time and allow scaling for large amounts of data. Such partitioning improves performance as a user can specify, or a database server can detect, a slice for each partition and process a query request only against those partitions having data relevant thereto. Scalability is also improved as the database server can prepare data in concrete chunks and perform its operations on the chunks rather efficiently. However, as the amount of data stored in association with a particular multidimensional database increases, the number of partitions required for the data becomes difficult to manage, both in terms of administration and server support, largely due to the overhead maintenance requirements of each partition.

### BRIEF SUMMARY

Embodiments of the present invention relate to systems and methods for storing and retrieving data items in multidimensional databases, e.g., Online Analytical Processing (OLAP) databases. Data partition templates are generated for grouping data partitions that are similar to one another, that is, that contain information specified according to particular common characteristics (for instance, time, product, geography, etc.). The data partition template includes one or more rules concerning how the data stored in partitions associated with the data partition template should be processed. A template object having the rule(s) associated therewith is generated for the data partition template. Once a data partition template is generated, a plurality of partitions are generated in accordance with the data partition template. Each of the plurality of partitions utilizes the template object associated with the data partition template rather than having a template object of its own. In this way, the overhead associated with managing the partitions is significantly decreased, particularly as the amount of data stored in association with the multidimensional database and the number of partitions associated therewith increases.

This Summary is provided to generally introduce the reader to one or more select concepts described below in the Detailed Description in a simplified form. The Summary is not intended to identify key and/or required features of the claimed subject matter, nor is it intended to be used as an aid in determining the scope of the claimed subject matter.

### BRIEF DESCRIPTION OF THE DRAWINGS

Illustrative embodiments of the present invention are described in detail below with reference to the attached drawing figures, wherein:

FIG. 1 is a schematic diagram illustrating how a multidimensional database including a plurality of data partitions grouped in accordance with data partition templates may be organized in accordance with an embodiment of the present invention;

FIG. 2 is a schematic diagram illustrating an exemplary system for processing and retrieving data stored in association with partitions grouped based upon data partition templates, in accordance with an embodiment of the present invention;

FIG. 3 is a flow diagram showing a method for storing data items in a multidimensional database based on data partition templates, in accordance with an embodiment of the present invention;

FIG. 4 is a flow diagram showing a method for retrieving data stored in a multidimensional database based on data partition templates, in accordance with an embodiment of the present invention; and

FIG. 5 is a flow diagram showing a method for storing and retrieving data in association with a multidimensional database, in accordance with an embodiment of the present invention.

### DETAILED DESCRIPTION

The subject matter of the present invention is described with specificity herein to meet statutory requirements. However, the description itself is not intended to limit the scope of the patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various stems herein disclosed unless and except when the order of the individual steps is explicitly described.

Embodiments of the present invention provide systems, methods and computer storage media having computer-useable instructions embodied thereon for storing data items in a multidimensional database (for instance, an OLAP database) based on data partition templates. Partition templates define rules regarding how data stored in association therewith should be processed. Defining the rule one time for a partition template reduces the necessity of defining the same rule with respect to a plurality of similar partitions, as more fully described below.

In one embodiment, a data partition template defined according to at least one dimension (e.g., time, geography, product, or the like) is received. A template object including the metadata and other overhead associated therewith is generated for the data partition template. Upon receipt of a data item having a first characteristic (e.g., a particular month, week, day or hour; or a particular country, state, region, or city) belonging to or corresponding with the at least one dimension, a first partition is generated in accordance with the data partition template. A slice defining the first partition and describing the portion of data stored in association therewith is also generated. The first partition is generated based upon the data partition template and utilizes the template object associated with the data partition template. That is, a separate template object is not generated for the first partition itself, thereby saving the overhead associated therewith. The received data item is then stored in association with the first partition.

Further embodiments of the present invention provide systems, methods and computer storage media having computer-useable instructions embodied thereon for retrieving data stored in a multidimensional database (e.g., an OLAP database) based upon data partition templates. The multidimensional database includes a plurality of partitions generated based upon a data partition template having a template object associated therewith. Initially, a query request is received to locate at least one data item in the multidimensional database. A slice is then located in a map associated with the data partition template, the slice being associated with one of the plurality of partitions with which the data item is associated. The data item is then retrieved from the one of the plurality of partitions associated with the slice.

Still further, embodiments of the present invention provide systems, methods, and computer storage media having computer-useable instructions embodied thereon for storing and retrieving data in association with a multidimensional database (e.g., and OLAP database). A data partition template defined according to at least one dimension (for instance, time) is received. A template object (having the metadata and other overhead associated therewith) associated with the data partition template is generated. A first data item having a first characteristic (e.g., being associated with a first hour of the day) belonging to the at least one dimension is received, and a first partition and a first slice associated therewith are generated, wherein the first slice defines the first partition, and wherein the first partition is associated with the data partition template and utilizes the template object. That is, a separate template object is not generated for the first partition thereby saving the overhead associated therewith. A second data item is then received having a second characteristic (e.g., being associated with a second hour of the day) different from the first characteristic and belonging to the at least one dimension. A second partition and a second slice associated therewith are then generated, wherein the second slice defines the second partition and wherein the second partition is associated with the data partition template and utilizes the template object, that is, a separate template object is not generated for the second partition. The first data item is stored in association with the first partition and the second data item is stored in association with the second partition. A map is also generated including a first path from the first slice to the first partition and a second path from the second slice to the second partition. A query request is then received to locate the first data item (that is, e.g., to locate data associated with the particular hour of the day) in the multidimensional database. The map is then utilized to locate the slice associated with the appropriate data item and the appropriate data item is retrieved from the first partition.

Having briefly described an overview of the present invention, an exemplary operating environment for the present invention is now described. In one embodiment, the present invention may be implemented utilizing a network system. A network system is but one example of a suitable computing environment and is not intended to suggest any limitation as to the scope of use or functionality of the invention. Neither should the network system be interpreted as having any dependency or requirement relating to any one or combination of components illustrated.

Embodiments of the present invention may be described in the general context of computer code or machine-usable instructions, including computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including, but not limited to, hand-held devices, consumer electronics, general purpose computers, specialty computing devices, and the like. Embodiments of the invention may also be practiced in distributed computing environments where tasks are performed by remote processing devices that are linked through a communications network. In a distributed computing environment, program modules may be located in association with both local and remote computer storage media including memory storage devices. The computer useable instructions form an interface to allow a computer to react according to a source of input. The instructions cooperate with other code segments to initiate a variety of tasks in response to data received in conjunction with the source of the received data.

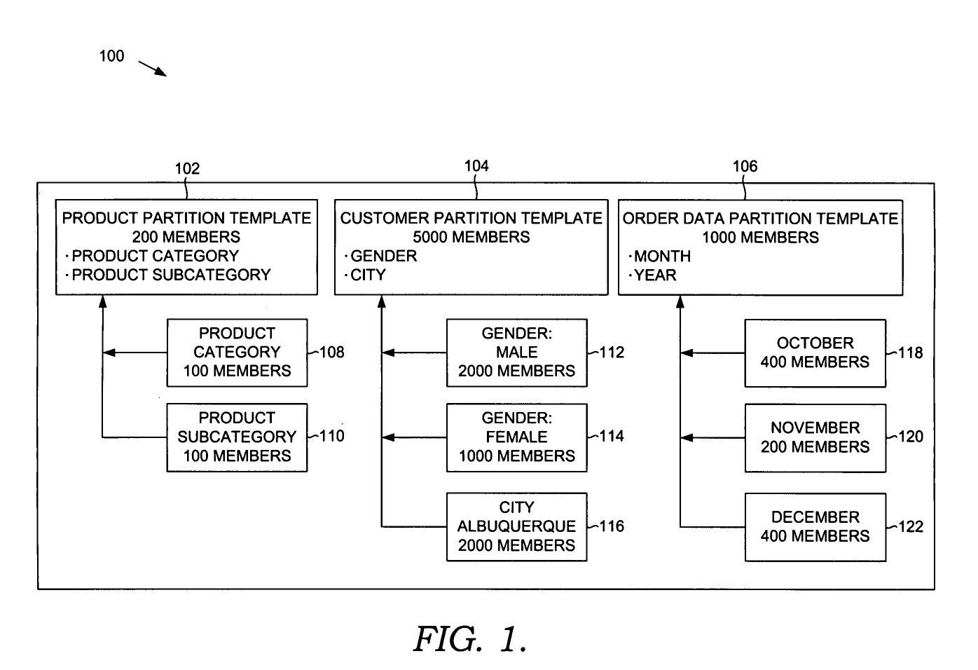

Turning now to FIG. 1, a schematic diagram illustrating how a multidimensional database 100 including a plurality of data partitions 108, 110, 112, 114, 116, 118, 120, 122 grouped in accordance with data partition templates 102, 104, 106 may be organized in accordance with an embodiment of the present invention is illustrated. The multidimensional database 100 may be, for instance, an OLAP database. In such an embodiment, the multidimensional database uses an Online Analytical Processing (OLAP) approach to quickly retrieve query results that are multidimensional in nature. For example, if a user submits a request for sales dollars in a specified year and sales dollars in a geographical location, this type of request is considered multidimensional since it includes sales dollars for a year and geographical location, two separate but related dimensional areas. Further, though illustrated as a single, independent component, the multidimensional database 100 may, in fact, be a plurality of databases.

The illustrated multidimensional database 100 includes a plurality of data partitions 108, 110, 112, 114, 116, 118, 120, and 122 grouped based upon the similarity of the data items associated therewith and in accordance with a data partition template 102, 104, 106. It will be understood and appreciated by those of ordinary skill in the art that the number and nature of the partitions and data partition templates illustrated in FIG. 1 are exemplary only and are not intended to be limiting of the invention in any way.

The data partitions 108, 110, 112, 114, 116, 118, 120, and 122 are located within the multidimensional database to organize and store data items based upon their relevancy to one another for quicker and more efficient data processing and retrieval. Received data items are analyzed and in turn, data partitions corresponding to data partition templates 102, 104, 106 are generated (as more fully described below). For example, the product category data partition 108 contains one hundred members and the product subcategory data partition 110 also includes one hundred members. The product category and sub-category represent characteristics of the data items associated therewith that belong to the dimension associated with the product partition template 102 which contains two hundred members, the members of each of the product category and subcategory. Similarly, the customer data partition template 104 includes five thousand members, those customers that are male (partition 112), those customers that are female (partition 114), and those customers that are affiliated with the city of Albuquerque (partition 116). These data partitions 112, 114, and 116 share at least one common characteristic (e.g., customers of store X) that is defined as the dimension of customer partition template 104.

The data partitions 118, 120, and 122 display an additional example of data partitions associated with a particular data partition template. By way of example and not of limitation, the October data partition 118 includes four hundred members, the November data partition 120 includes two hundred members, and the December data partition 122 includes four hundred members. Each of the data partitions 118, 120, 122 share at least one common characteristic (e.g., sales in a particular month of year X) that is defined as the dimension of order data partition template 106.

The data partition templates 102, 104, and 106 are used in accordance with the present invention to increase efficiency when a user queries a database 100 by grouping data partitions sharing common characteristics that correspond with a dimension defined by the data partition template. In this aspect, only one data partition template is utilized to generate a plurality of separate data partitions, each data partition utilizing the template object associated with the data partition template, thereby saving the overhead associated with management and maintenance of a separate object for each partition. For example, the data partition template 102 combines relevant data partitions 108 and 110 in accordance with the product partition template which is considered one object. In another aspect of the present invention, the product partition template also contains the corresponding data items within the data partitions 108, 110. The customer partition template 104 includes five thousand members and includes relevant data items within the data partitions 112, 114 and 116 pertaining to gender and city as indicated in FIG. 1. The order partition template 106 includes one thousand members and includes relevant data partitions 118, 120, and 122 corresponding to the month and year. Each of these partition templates 102, 104, 106 are generated to organize and store data items having relevancy to one another.

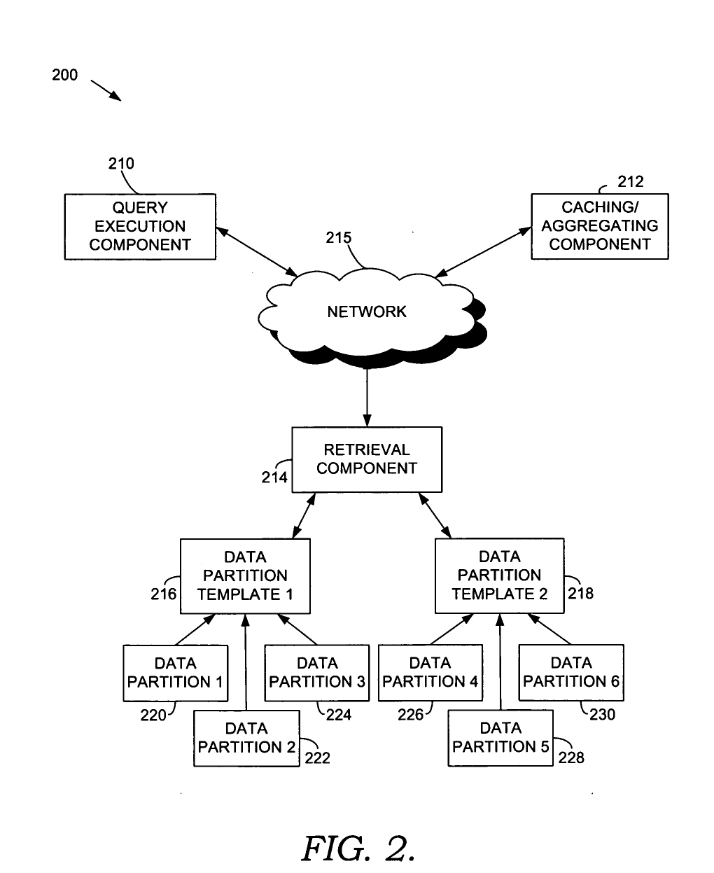

Turning now to FIG. 2, a schematic diagram illustrating an exemplary system 200 for processing and retrieving data stored in association with partitions grouped based upon data partition templates, in accordance with an embodiment of the present invention, is shown. It will be understood and appreciated by those of ordinary skill in the art that the system shown in FIG. 2 is merely an example of one suitable computing system environment and is not intended to suggest any limitation as to the scope of use or functionality of embodiments of the present invention. Neither should the system be interpreted as having any dependency or requirement related to any single component or combination of components illustrated therein. Further, the system may be provided as a stand-alone product, as part of a software development environment, or any combination thereof.

The system includes a query execution component 210, a caching or aggregating component 212 and a retrieval component 214, all in communication with one another via a network 215. The network 215 may include, without limitation, one or more local area networks (LANs) and/or wide area networks (WANs). Such networking environments are commonplace in offices, enterprise-wide computer networks, intranets, and the Internet. Accordingly, the network 215 is not further described herein.

As shown in FIG. 2, the query execution component 210 is configured to receive query requests to locate data items within a multidimensional database. The multidimensional database being queried includes a plurality of partitions generated based upon data partition templates, as more fully described below. By way of example only, received query requests may include data requirements according to a multidimensional expression (MDX) query language while other aspects outline query compressed into packets of information and transmitted to a networking system. Yet another aspect of a query involves using a structured query language (SQL). For example, a query search may be a word, question, or statement entered in MDX and designed to elicit responses. Accordingly, another example a query search is composed in SQL query language and compressed into packets of information.

The caching or aggregating component 310 may include cached query search results and/or aggregated data items. Aggregations include, for instance, sums of data items included in the multidimensional database. For instance, sales of product A for day X may be aggregated and sales of product B for day X may be aggregated. Subsequently, when a query request for sales for day X is received, the caching or aggregating component may be queried to retrieve the sales information for products A and B rather than the partitions from which the data was aggregated. Such aggregations may then be cached, if desired. The query search results or data items may be files, and/or references to the data items contained in the multidimensional database. In embodiments, the query execution component 210 queries the caching component 212 rather than, or in addition to, querying the entire multidimensional database. It should be noted that all partitions associated with a particular data partition template utilize the same aggregations.

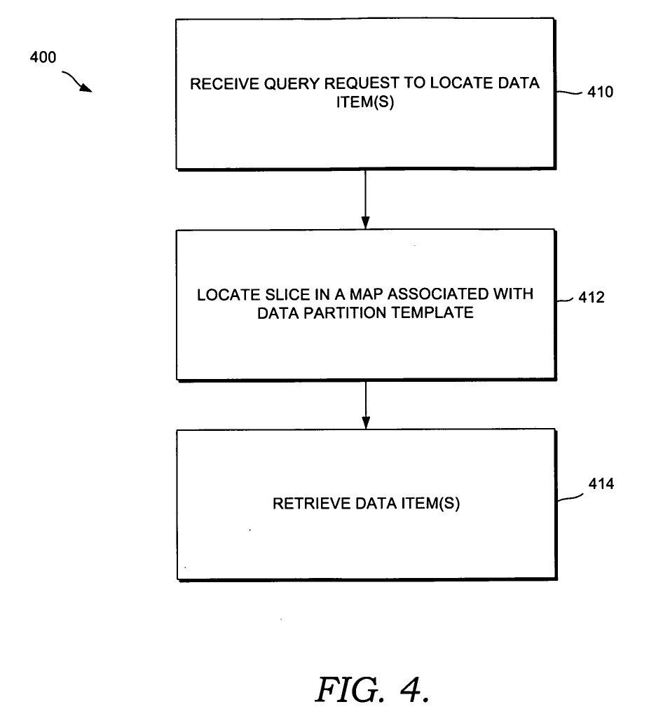

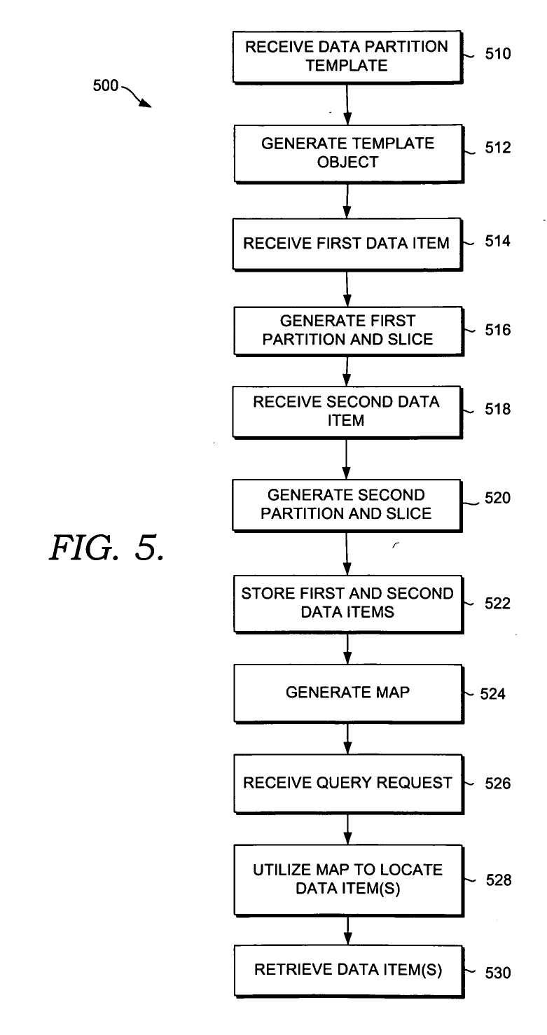

The retrieval component 214 is configured to retrieve data items from a plurality of data partitions 220, 222, 224, 226, 228, 230 within a multidimensional database, the data partitions 220, 222, 224, 226, 228, 230 being organized based upon data partitions 216, 218. Retrieval of data items is more fully described herein below with reference to FIGS. 4 and 5.

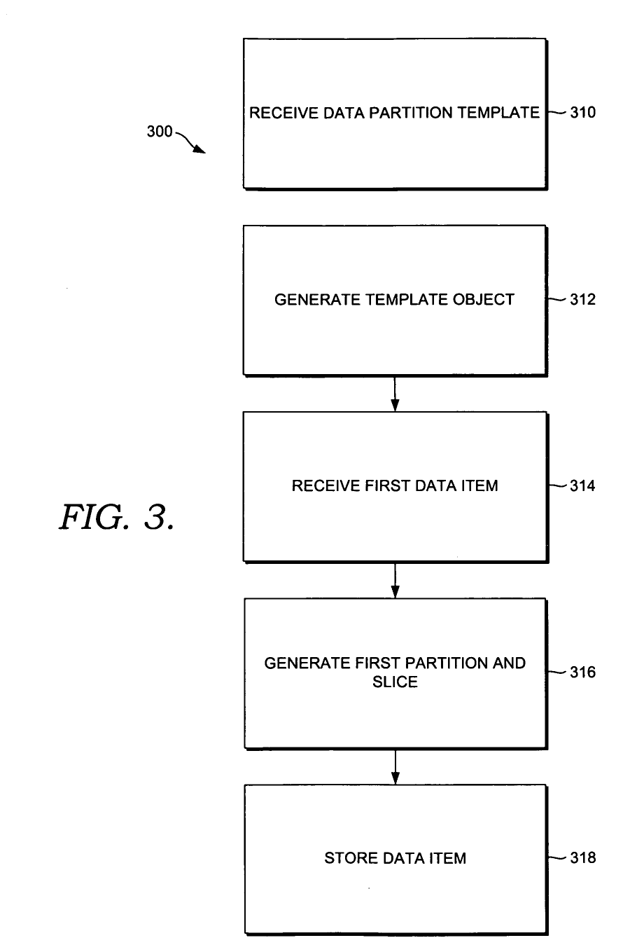

Turning now to FIG. 3, a flow diagram 300 is illustrated showing a method for storing data items in a multidimensional database based on data partition templates, in accordance with an embodiment of the present invention. Initially, as indicated at block 310, a data partition template defined according to at least one dimension (e.g., time, product, geography, and the like) is received. The data partition template may be manually created by, for instance, a database system administrator, or may be automatically generated based upon identified similarities between data items stored in association with the multidimensional database. Any and all such variations, and any combination thereof, are contemplated to be within the scope of embodiments of the present invention.

Subsequently, as indicated at block 312, a template object is generated, the template object being associated with the data partition template. The template object includes the metadata and other overhead associated with maintaining and managing the data partition template. It should be noted that if the data partition template is manually generated, the template object may similarly be manually generated and received rather than generated by the system. Next, as indicated at block 314, a first data item is received. The received data item includes a characteristic associated with the dimension associated with the data partition template. For instance, if the dimension associated with the data partition template is time, the characteristic of the received data item may be a product sale within a particular hour of the day (that is, the characteristic may be “hour X”). Similarly, if the dimension associated with the data partition template is geography, the characteristic of the received data item may be “Seattle”.

Next, as indicated at block 316, a first partition is generated. The partition is generated according to the rule defined by the data partition template but a separate template object associated with the first partition is not generated. Also generated is a slice associated with the first partition. As described herein above, a “slice” is a property of the partition that describes the portion of data stored in association therewith. Lastly, the received first data item is stored in association with the partition, as indicated at block 318.

Upon subsequent receipt of a second data item having a second characteristic, different from the first characteristic but still belonging to the at least one dimension, a second partition and slice may be generated. That is, consider that a second data item having the characteristic of “hour Y” is received. This second data item still belongs to the partition having the dimension of “time” but the characteristic is different from that of the first partition. Accordingly, a second partition may be generated utilizing the data partition template for storage of the second data item. As with the first partition, the second partition does not include a separate template object but rather utilizes the template object associated with the data partition template. In this way, the overhead associated with management and maintenance of the template object is saved.

Though not illustrated in FIG. 3, in embodiments of the present invention, the slice generated for the first and second partitions, respectively, may be utilized to generate a map associated with the data partition template. Such a map includes a first path from the first slice to the first partition and a second path from the second slice to the second partition. Thus, upon receipt of a query request, the map may be utilized to locate the appropriate slice and, consequently, the appropriate partition from which data items satisfying the search request may be found. This partition may then be searched or queried rather than the entire multidimensional database.

With reference now to FIG. 4, a flow diagram showing a method for retrieving data stored in a multidimensional database based on data partition templates, in accordance with an embodiment of the present invention, is illustrated and designated generally as reference numeral 400. Initially, as indicated at block 410, a query request is received, for instance, utilizing query execution component 210 of FIG. 2. The received query request is to locate at least one data item in a multidimensional database that includes a plurality of partitions generated based upon data partition templates as discussed herein above. Subsequently, a slice in a map associated with the appropriate data partition template is located, as indicated at block 412, and the at least one data item is retrieved from the appropriate partition. This is indicated at block 414.

Turning to FIG. 5, a flow diagram showing a method for storing and retrieving data in association with a multidimensional database, in accordance with an embodiment of the present invention, is shown and designated generally as reference numeral 500. Initially, as indicated at block 510, a data partition template defined according to at least one dimension (e.g., time, geography, product, or the like) is received. Next, as indicated at block 512, a template object associated with the data partition template is generated (or received), the template object including the metadata and other overhead necessary to maintain and manage the partitions generated in accordance with the partition template. Subsequently, a first data item is received, the first data item having a first characteristic belonging to the at least one dimension. For instance, if the dimension is time, the first characteristic may be “hour X”. This is indicated at block 514. A first partition and slice are subsequently generated, as indicated at block 516. As previously described, the slice defines the first partition in that it describes the portion of data stored (or to be stored) in association therewith. The first partition utilizes the template object associated with the data partition template.

Next, as indicated at block 518, a second data item is received, the second data item having a second characteristic that differs from the first characteristic but belongs to the at least one dimension. For instance, if the dimension associated with the data partition template is time, the second characteristic may be “hour Y” (the first characteristic being, for instance, “hour X”). Next, as indicated at block 520, a second partition and slice are generated. As with the first partition, the second partition utilizes the template object associated with the data partition template. Each of the first and second data items are stored in association with the first partition and second partition, respectively, as indicated at block 522.

Subsequently, a map is generated that includes a first path from the first slice to the first partition and as second path from the second slice to the second partition. This is indicated at block 524. The map may then be utilized to locate data items satisfying received query requests, as more fully described below.

Next, a query request to locate a particular data item in the multidimensional database is received, as indicated at block 526. The map is then utilized to locate the slice associated with the relevant data item, as indicated at block 528, and the data item satisfying the received query is retrieved. This is indicated at block 530.

The present invention has been described herein in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain the ends and objects set forth above, together with other advantages which are obvious and inherent to the methods, computer-readable media, and systems. It will be understood that certain features and sub-combinations are of utility and may be employed without reference to other features and sub-combinations. This is contemplated by and within the scope of the claims.

The invention claimed is:

1. One or more computer storage media having computer-useable instructions embodied thereon for storing data items in a multidimensional database based on data partition templates, the method comprising:
receiving a data partition template defined according to at least one dimension;
generating a template object associated with the data partition template;
receiving a first data item having a first characteristic belonging to the at least one dimension;
generating a first partition and a first slice associated therewith, wherein the first slice defines the first partition and wherein the first partition is associated with the data partition template and utilizes the template object; and
storing the first data item in association with the first partition.

2. The one or more computer storage media of claim 1, wherein the multidimensional database is an OLAP database.

3. The one or more computer storage media of claim 1, wherein the at least one dimension includes one of time, product and geography.

4. The one or more computer storage media of claim 1, wherein the method further comprises:
receiving a second data item having a second characteristic, different from the first characteristic and belonging to the at least one dimension;
generating a second partition and a second slice associated therewith, wherein the second slice defines the second partition and wherein the second partition is associated with the data partition template and utilizes the template object; and
storing the second data item in association with the second partition.

5. The one or more computer storage media of claim 4, wherein the method further comprises:
generating a map including a first path from the first slice to the first partition and a second path from the second slice to the second partition.

6. The one or more computer storage media of claim 5, wherein the method further comprises:
receiving a query request to locate at least one of the first data item and the second data item in the multidimensional database; and
utilizing the map to locate the at least one of the first data item and the second data item.

7. The one or more computer storage media of claim 4, wherein the method further comprises:
storing a plurality of data items in association with the multidimensional database; and
generating at least one aggregation including at least a portion of the plurality of data items, wherein each of the first partition and the second partition include the at least one aggregation.

8. The one or more computer storage media of claim 4, wherein a separate template object is not generated in association with the first partition or the second partition.

9. The one or more computer storage media of claim 4, wherein the first partition and the second partition are automatically generated based on the data partition template upon receipt of the first data item and the second data item, respectively.

10. One or more computer storage media having computer-useable instructions embodied thereon for retrieving data stored in a multidimensional database based on data partition templates, the method comprising:
receiving a query request to locate at least one data item in the multidimensional database, the multidimensional database including a plurality of partitions generated based upon a data partition template having a template object associated therewith;
locating a slice in a map associated with the data partition template, the slice being associated with one of the plurality of partitions with which the data item is associated; and
retrieving the at least one data item from the one of the plurality of partitions.

11. The one or more computer storage media of claim 10, wherein the data partition template includes at least one rule for generating partitions.

12. The one or more computer storage media of claim 10, wherein a separate template object is not generated in association with the first partition or the second partition.

13. The one or more computer storage media of claim 10, wherein the at least one data item includes a characteristic belonging to at least one dimension.

14. The one or more computer storage media of claim 13, wherein the at least one dimension includes one of time, product and geography.

15. The one or more computer storage media of claim 10, wherein the data partition template groups the plurality of partitions according to common characteristics.

16. The one or more computer storage media of claim 10, wherein the method further comprises:
storing a plurality of data items in association with a plurality of partitions associated with the multidimensional database; and
generating at least one aggregation including at least a portion of the plurality of data items, wherein each of the plurality of partitions includes at least one aggregation.

17. The one or more computer storage media of claim 10, wherein the multidimensional database is an OLAP database.

18. A method for storing and retrieving data in association with a multidimensional database, the method comprising:
receiving a data partition template defined according to at least one dimension;
generating a template object associated with the data partition template;
receiving a first data item having a first characteristic belonging to the at least one dimension;
generating a first partition and a first slice associated therewith, wherein the first slice defines the first partition, and wherein the first partition is associated with the data partition template and utilizes the template object;
receiving a second data item having a second characteristic different from the first characteristic and belonging to the at least one dimension;
generating a second partition and a second slice associated therewith, wherein the second slice defines the second partition and wherein the second partition is associated with the data partition template and utilizes the template object;
storing the first data item in association with the first template and the second data item in association with the second template;
generating a map including a first path from the first slice to the first partition and a second path from the second slice to the second partition;
receiving a query request to locate the first data item in the multidimensional database;
utilizing the map to locate the slice associated with the first data item; and
retrieving the first data item from the first partition.

19. The method of claim 18, further comprising:
storing a plurality of data items in association with the multidimensional database; and
generating at least one aggregation including at least a portion of the plurality of data items, wherein each of the first partition and the second partition include the at least one aggregation.

20. The method of claim 18, wherein the multidimensional database is an OLAP database.
